(19) United States
(12) Patent Application Publication
(10) Pub. No.: US 2011/0148304 A1
(43) Pub. Date: Jun. 23, 2011

(54) THERMOELECTRIC COOLING FOR INCREASED BRIGHTNESS IN A WHITE LIGHT L.E.D. ILLUMINATOR

(76) Inventors: Alexander N. Artsyukhovich, San Juan Capistrano, CA (US); Mikhail Boukhny, Laguna Niguel, CA (US); Raphael Gordon, Ladera Ranch, CA (US); Michael J. Yadlowsky, Irvine, CA (US)

(21) Appl. No.: 12/947,985

(22) Filed: Nov. 17, 2010

Related U.S. Application Data
(60) Provisional application No. 61/289,145, filed on Dec. 22, 2009.

(51) Int. Cl. H01J 61/52; F21V 9/16

(52) U.S. Cl. 315/112; 362/84

(57) ABSTRACT

A white light source includes a light-emitting diode configured to emit light of a characteristic wavelength. The white light source also includes at least one phosphor. The phosphor is configured to emit light in response to the light emitted by the light-emitting diode so that the white light source emits white light. The white light source further includes a thermally conductive base in thermal contact with the light-emitting diode and a thermo-electric cooler in thermal contact with the thermally conductive base.

### RELATED APPLICATIONS

This application claims priority to U.S. provisional application Ser. No. 61/289,145, filed on Dec. 22, 2009, the contents which are incorporated herein by reference.

### FIELD OF THE INVENTION

This invention relates to white-light illumination sources, and, more particularly to thermoelectric cooling for increased brightness in a white light LED illuminator.

### BACKGROUND OF THE INVENTION

Light-emitting diodes (LEDs) are desirable for generating white-light illumination in that they consume considerably less energy than comparable light sources, they have a long lifetime, and they are comparatively easy to power and control. LEDs of a particular wavelength can be used with white phosphor material or other phosphorescent materials in combination with the light produced by the LED to produce white light. But there are also drawbacks to the use of LEDs that can make them undesirable as light sources in optical fiber illuminators, such as ophthalmic endoilluminators. One drawback is that the brightness of LEDs may not be sufficient to provide effective illumination. The LED may be run at a higher current to increase the brightness, but this can shorten the lifetime of the semiconductor junction generating the light. Accordingly, there remains a need for an LED with sufficient brightness that also has a longer life.

### BRIEF SUMMARY OF THE INVENTION

In particular embodiments of the present invention, a white light source includes a light-emitting diode configured to emit radiation of a characteristic wavelength. The white light source also includes at least one phosphor. The phosphor is configured to emit light in response to the radiation emitted by the light-emitting diode so that the white light source emits white light. The white light source further includes a thermally conductive base in thermal contact with the light-emitting diode and a thermo-electric cooler in thermal contact with the thermally conductive base.

In particular embodiments of the present invention, a method of providing white light illumination includes providing a white light source comprising a light-emitting diode configured to emit radiation of a characteristic wavelength, at least one phosphor, and a thermally conductive base. The phosphor is configured to emit light in response to the radiation emitted by the light-emitting diode so that the white light source emits white light, and a thermally conductive base. The method also includes powering the light-emitting diode with a current sufficient to heat the light-emitting diode to a temperature significantly above an ambient temperature when the light-emitting diode is passively cooled by thermal contact with the thermally conductive base. The method further includes cooling the thermally conductive base with a thermo-electric cooler during the step of powering the light-emitting diode with the current to maintain the temperature of the light-emitting diode near the ambient temperature

Other objects, features and advantages of the present invention will become apparent with reference to the drawings, and the following description of the drawings and claims.

### BRIEF DESCRIPTION OF THE DRAWINGS

FIG. 1 illustrates a white light source according to a particular embodiment of the present invention; and

FIG. 2 is a flow chart illustrating an example method of generating white light illumination according to a particular embodiment of the present invention.

### DETAILED DESCRIPTION OF THE INVENTION

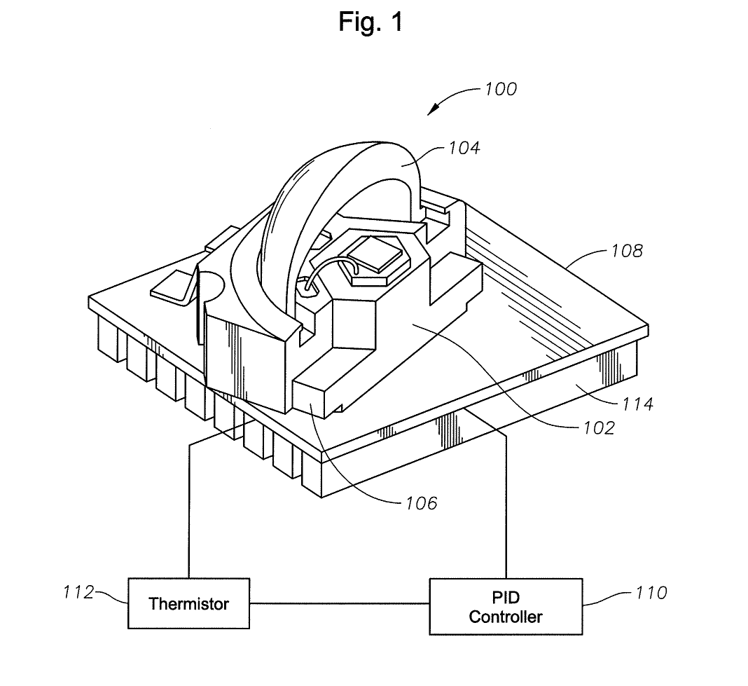

FIG. 1 illustrates a white light source 100 according to a particular embodiment of the present invention. In the depicted embodiment, the white light source 100 includes a light-emitting diode (LED) 102 with a phosphor cap and a dome lens 104(shown cut away for visibility of the LED 102). The LED 102 comprises a semiconductor junction that emits light when powered by a current, and the LED 102 may be formed as a semiconductor chip, such as in the illustrated embodiment. When the LED 102 is powered, the LED 102 emits electromagnetic radiation of a characteristic wavelength, such as ultraviolet (UV) radiation and/or blue or violet light. In response to radiation emitted by the LED 102, the phosphor cap produces light such that the combination of the radiation emitted by the LED 102 and the light emitted by the phosphor cap appears essentially white. Because of the configuration of the LED 102 and the phosphor required to effectively produce and collimate white light, LED white light sources are ordinarily arranged in a casing to hold the LED 102 and the dome lens 104 in a particular arrangement. But because of the fixed arrangement of the components, the LED 102 is not directly accessible. Thus, while high-energy laser diodes are ordinarily cooled by direct contact with a thermo-electric cooler, such cooling is not conventionally available for LED white light sources.

Various embodiments provide cooling for LEDs used in white light sources by coupling the LED 102 to a thermally conductive base 106, which is in turn placed in thermal contact with a thermo-electric cooler (TEC) 108. In a particular embodiment, the thermally conductive base 106 is formed from copper. The TEC 108 may be any of a number of electrically controlled active cooling devices, such as the TECs used to cool laser diodes. The TEC 108 may be controlled by a controller 110, such as a proportional-integral-derivative (PID) controller, using temperature feedback measured by a temperature sensor 112, such as a thermistor places in contact with the TEC 108.

In order for the TEC 108 to more effectively cool the LED 102, heat may also be carried away from the TEC 108 by coupling the TEC 108 to a heat sink 114. The heat sink 114 may be any suitable volume of material in thermal contact with the TEC 108 so as to remove a significant portion of the heat generated at a hot side of the TEC 108. The TEC 108 may also be air-cooled by a fan 114 or fluid-cooled to maintain the temperature of the TEC 108 sufficiently low to maintain the LED 102 at a temperature near an ambient temperature of a local environment of the white light source 100 (“near” in this context referring to a temperature no more than 10 degrees Celsius in excess of the ambient temperature).

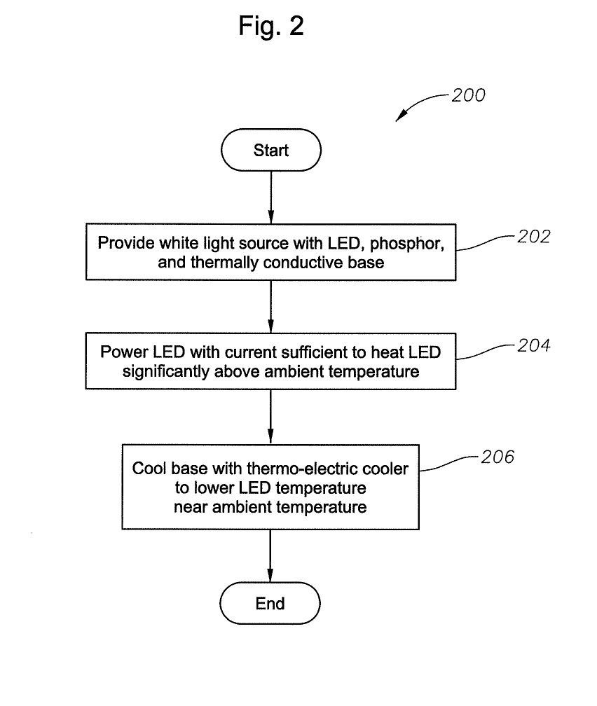

FIG. 2 is a flow chart 200 illustrating an example method of providing white light illumination according to a particular embodiment of the present invention. A white light source, such as white light source 100, is provided at step 202. The white light source includes an LED and a phosphor such that the white light source is configured to emit white light when the LED is powered, which is in turn provided on a thermally conductive base. At step 204, the LED is powered with a current sufficient to heat the LED significantly above an ambient temperature if the LED were only passively cooled by the thermally conductive base. For purposes of this specification, “significantly above” refers to a temperature difference of at least ten degrees Celsius above an environmental temperature of the LED. In a typical case for maximum brightness, for example, an LED might be powered with a current of 1.5 A or greater, which could heat the p-n junction of the LED to a temperature of over 130 degrees Celsius even with passive cooling in place.

Finally, at step 206, the thermally conductive base is cooled with a thermo-electric cooler to maintain the LED at a temperature near the ambient temperature. “Near” means that the temperature is no more than ten degrees Celsius above the ambient temperature, as contrasted with “significantly above.” In particular embodiments, however, the cooled temperature of the LED may be lower than, and even significantly lower than, the ambient temperature. For example, given an ambient temperature of around 25 degrees Celsius, the operating temperature of the LED in typical conditions could be as low as 5 degrees Celsius. Preferably, the temperature is maintained sufficiently high to avoid condensation. In particular embodiments, the side of the thermo-electric cooler opposite the LED may be further cooled with a heat sink, forced air (such as by directing a fan at the thermo-electric cooler), liquid/thermostatic cooling, or other heat removal structures.

The present invention is illustrated herein by example, and various modifications may be made by a person of ordinary skill in the art. Although the present invention is described in detail, it should be understood that various changes, substitutions and alterations can be made hereto without departing from the scope of the invention as claimed.

what is claimed is:

1. A white light source, comprising:
a light-emitting diode configured to emit radiation of a characteristic wavelength;
at least one phosphor, the phosphor configured to emit light in response to the light emitted by the light-emitting diode so that the white light source emits white light;
a thermally conductive base in thermal contact with the light-emitting diode; and
a thermo-electric cooler in thermal contact with the thermally conductive base.

2. The white light source of claim 1, further comprising a cooling fan configured to direct air at the thermo-electric cooler.

3. The white light source of claim 1, further comprising a heat sink in thermal contact with the thermo-electric cooler.

4. The white light source of claim 1, further comprising a proportional-integral-derivative (PID) controller configured to regulate a temperature of the thermo-electric cooler.

5. The white light source of claim 4, further comprising a thermistor in contact with the thermo-electric cooler providing feedback to the PID controller.

6. The white light source of claim 1, wherein the thermally conductive base is formed from copper.

7. The white light source of claim 1, wherein an operating temperature of the light-emitting diode is greater than 130 degrees Celsius when the light-emitting diode is passively cooled by the thermally conductive base and less than 25 degrees Celsius when the thermo-electric cooler is actively cooling the thermally conductive base.

8. A method of providing white light illumination, comprising:
providing a white light source comprising a light-emitting diode configured to emit radiation of a characteristic wavelength, at least one phosphor, the phosphor configured to emit light in response to the light emitted by the light-emitting diode so that the white light source emits white light, and a thermally conductive base;
powering the light-emitting diode with a current sufficient to heat the light-emitting diode to a temperature significantly above an ambient temperature when the light-emitting diode is passively cooled by thermal contact with the thermally conductive base; and
cooling the thermally conductive base with a thermo-electric cooler during the step of powering the light-emitting diode with the current to maintain the temperature of the light-emitting diode near the ambient temperature.

9. The method of claim 8, further comprising cooling the thermo-electric cooler to prevent heat in the thermo-electric cooler from raising the temperature of the light-emitting diode above the ambient temperature.

10. The method of claim 8, further comprising placing the thermally conductive base in contact with a heat sink.

11. The method of claim 8, wherein the current is higher than 1.5 A.

12. The method of claim 8, wherein the temperature of the light-emitting diode when passively cooled is at least 130 degrees Celsius and the temperature of the light-emitting diode when cooled by the thermo-electric cooler is less than 25 degrees Celsius.

13. The method of claim 8, wherein the temperature of the light-emitting diode when cooled is 5 degrees Celsius or less.
